(19) United States
(12) Patent Application Publication
(10) Pub. No.: US 2015/0197615 A1
(43) Pub. Date: Jul. 16, 2015

(54) Expandable and Expanded Thermoplastic Materials and Methods Thereof

(71) Applicant: Presidium USA Inc., Stamford, CT (US)

(72) Inventor: James Blumsom, London (CA)

(21) Appl. No.: 14/596,563

(22) Filed: Jan. 14, 2015

Related U.S. Application Data
(60) Provisional application No. 61/927,774, filed on Jan. 15, 2014.

(51) Int. Cl. C08J 9/224

(52) U.S. Cl. CPC C08J 9/224

(57) ABSTRACT

Disclosed in certain embodiments is an expandable foam comprising (i) a plurality of spheres comprising a thermoplastic material, the spheres encapsulating a propellant material and (ii) a coupling agent forming a bond between at least a portion of adjacent spheres

### BACKGROUND OF THE INVENTION

Expandable foams are common for many types of uses, including insulation, impact resistance, packaging, walling material, car components and aerospace structural cones. Expandable foams are typically made of packed hollow microspheres due to their low density and increased impact strength. In particular, hollow spheres provide a particular advantage by reducing the overall weight of the product while still having the same volume of a solid counterpart.

Among the many applications of expandable thermoplastics, these materials are widely used for impact resistant applications. For example, expandable thermoplastic materials are commonly used in the lining of sporting equipment helmets used in activities such as bicycling, football, hockey and lacrosse. Unfortunately, this lining of thermoplastic materials does not provide sufficient impact resistance and the user is still susceptible to significant injury or death which may be avoided with better materials.

A concussion is a traumatic brain injury that alters the way your brain functions. Effects are usually temporary, but can include problems with headache, concentration, memory, judgment, balance and coordination. In high impact sports, such as football and auto-racing, concussions are a growing concern, especially as recent research suggests multiple concussions may result in both short and long-term brain damage.

There exists a need in the art for improved thermoplastic materials that have improved characteristics as compared to current materials. These characteristics may include improvements in impact resistance, durability, manufacturing or fire resistance.

### OBJECTS AND SUMMARY OF THE INVENTION

It is an object of certain embodiments to provide an improved thermoplastic material.

It is an object of certain embodiments to provide an improved expandable thermoplastic material.

It is an object of certain embodiments to provide an improved expanded thermoplastic material.

It is an object certain embodiments of the present invention to provide a thermoplastic material that has improved impact resistance as compared to known materials.

It is an object of certain embodiments of the present invention to provide a thermoplastic material that has improved insulation resistance as compared to known materials.

It is an object of certain embodiments of the invention to provide improved impact resistant helmets utilizing the compositions as disclosed herein.

It is an object of certain embodiments of the invention to provide molded materials utilizing the compositions as disclosed herein.

It is an object of certain embodiments of the present invention to provide processes for preparing the compositions as disclosed herein.

The above objects and others, may be met by the present invention which in certain embodiments is directed to an expandable foam comprising (i) a plurality of spheres comprising a thermoplastic material, the spheres encapsulating a propellant material and (ii) a coupling agent forming a bond between at least a portion of adjacent spheres.

It is an object of certain embodiments of the invention to provide a method of preparing an expanded foam comprising a plurality of bonded hollow spheres comprising heating an expandable foam comprising (i) a plurality spheres comprising a thermoplastic material, the spheres encapsulating a propellant material that becomes gaseous at a temperature below the thermoplastic temperature of the particle and (ii) a coupling agent forming a bond between at least a portion of adjacent spheres, to a temperature sufficient to cause plasticization of the material to form expanded spheres having a gaseous center, and cooling the spheres to a temperature below the thermoplastic temperature.

It is an object of certain embodiments of the invention to provide a method of preparing an expandable foam comprising mixing (i) a plurality of spheres comprising a thermoplastic material, the spheres encapsulating a propellant material and (ii) a coupling agent, such that a bond forms between at least a portion of adjacent spheres.

It is an object of certain embodiments of the invention to provide an expandable foam comprising (i) a plurality of spheres comprising a thermoplastic material, the spheres encapsulating a propellant material and at least one of (ii) a coupling agent, (iii) a binder and (iv) a reinforcing agent, wherein the expandable foam is capable of forming an expanded foam having an impact resistance of at least 20 G/inch or at least 200 G/inch.

It is an object of certain embodiments of the invention to provide an expanded foam comprising (i) a plurality of spheres comprising a thermoplastic material, the spheres encapsulating a propellant material and at least one of (ii) a coupling agent, (iii) a binder and (iv) a reinforcing agent, wherein the expanded foam has an impact resistance of at least 20 G/inch or at least 200 G/inch.

It is an object of certain embodiments of the invention to provide an expandable foam comprising (i) a plurality of spheres comprising a thermoplastic material, the spheres encapsulating a propellant material and (ii) a reinforcing agent, in a ratio of spheres to reinforcing agent of from about 1:1 to about 1:99.

It is an object of certain embodiments of the invention to provide an expanded foam comprising (i) a plurality of spheres comprising a thermoplastic material, the spheres encapsulating a propellant material and (ii) a reinforcing agent, in a ratio of spheres to reinforcing agent of from about 1:1 to about 1:99.

It is an object of certain embodiments of the invention to provide an expandable foam comprising (i) a plurality of spheres comprising vinylidene chloride/acrylonitrile copolymer and isobutane and (ii) a coupling agent forming a bond between at least a portion of adjacent spheres.

It is an object of certain embodiments of the invention to provide an expanded foam formed by the application of heat to an expandable foam as disclosed herein.

It is an object of certain embodiments of the invention to provide an expanded foam comprising (i) a plurality of spheres comprising vinylidene chloride/acrylonitrile copolymer and isobutane and (ii) a reinforcing agent, in a ratio of spheres to reinforcing agent of from about 1:1 to about 1:99.

It is an object of certain embodiments of the invention to provide an expanded foam formed by the application of heat to an expandable foam as disclosed herein.

The term “gravity” (“G”) is defined for purpose of the present invention as an acceleration equal to the acceleration of gravity, 980.665 centimeter-second-squared, approximately 32.2 feet per second per second at sea level and used as a unit of stress measurement for bodies undergoing acceleration.

The term “velocity” is defined for the purpose of the present invention as the rate at which an object changes its position.

The term “acceleration” is defined for the purpose of the present invention as the rate at which an object changes its velocity.

### DETAILED DESCRIPTION

The present invention is directed in certain embodiments to an expandable thermoplastic foam and a method for producing and using such a material. The foam may comprise microspheres and one or more of a coupling agent, a binder and a reinforcing material.

The final characteristics (e.g., impact resistance) of the thermoplastic material can also be manipulated by varying the inclusion of, selection of or the quantity of the binder, reinforcing agent or coupling agent.

In one embodiment the foam may include a mixture of microspheres made from a thermoplastic material containing a propellant material and a coupling agent and may include a binder and/or a reinforcing agent with the expandable foam being capable of forming an expanded foam having an impact resistance of at least 20 G/inch or at least 20 G/inch.

In another embodiment, the expanded foam may comprise of a plurality of spheres comprising a thermoplastic material, the spheres encapsulating a propellant material, and at least one coupling agent, binder and/or reinforcing agent, wherein the expanded foam has an impact resistance of at least 20 G/inch or at least 200 G/inch.

The expandable foam may also include thermoplastic spheres having a propellant in their interior, and a reinforcing agent, in a ratio of spheres to reinforcing agent of from about 1:1 to about 1:99.

The foam may be in the form of a liquid, powder, pellet, slurry or a combination thereof. The foam can be made flexible by adding, e.g., elastomers and flexible agents into the mixture before expansion. In some embodiments, the foam may be formulated to be rigid. In some embodiments, the foam may be rigid by adding carbon nanotubes, long or short carbon fiber, epoxy resins or polyurea into the foam mixture before expansion.

In some embodiments, the coupling agent will form a bond between at least some of the adjacent spheres. The coupling agent may include, without limitation, transition metal atoms selected from Group IVB, Group VB and Group VIB of the Periodic Chart, transition metal alkoxide or maleic anhydride copolymer, or a combination thereof. In other embodiments, the coupling agent may comprise titanium, zirconium, derivatives thereof and combinations thereof.

In certain embodiments, the spheres may be microspheres. The spheres may have a shell that may be made from a thermoplastic material, such as a polymer or copolymer. The polymer or copolymer may be selected from, but not limited to, vinyl chloride, vinylidene chloride, acrylonitrile with vinyl chloride, vinyl bromide, a halogenated vinyl compound or a combination thereof. The polymer or copolymer may also be selected from, but not limited to, styrene, o-methylstyrene, m-methylstyrene, p-methylstyrene, ethylstyrene, ar-vinyl-xylene, ar-chlorostyrene, ar-bromostyrene, vinylbenzylchloride p-tert.-butylstyrene or a combination thereof.

One of the possible materials that may comprise the thermoplastic shell of a sphere may be an acrylate material. The acrylate material may include, without limitation, methyl methacrylate, ethyl acrylate, propyl acrylate, butyl acrylate, butyl methacrylate, propyl methacrylate, butyl methacrylate, lauryl acrylate, 2-ethylhexylacrylate, ethyl methacrylate or a combination thereof.

In some embodiments of the foam, the coupling agent and the thermoplastic material may be mixed by ultrasonic waves, high sheer, ultra high sheer or a mixture thereof. The coupling agent may also be broken down into monomers and dispersed across the spheres prior to expansion. In some embodiments, expansion occurs when heat is applied to the spheres.

In other embodiments, the sphere can contain a liquid, such as a propellant. The propellant may be a volatile fluid-forming agent, such as an aliphatic hydrocarbon. The aliphatic hydrocarbon may be selected from, but not limited to, ethane, ethylene, propane, propene, butene, isobutene, neopentane, acetylene, hexane, heptane, halogenated derivatives thereof and mixtures thereof. The propellant may also be selected from trichlorofluoromethane, n-pentane, iso-pentane, neopentane, butane, isobutane or a mixture thereof. The propellant may have a boiling point below the softening point of the thermoplastic material when saturated with the propellant.

In certain embodiments, the propellant may be from about 1% to about 70% w/w of the sphere. In other embodiments, the propellant may be from about 2% to about 50% or about 5% to about 30% w/w of the sphere.

The unexpanded spheres may have a size from about 1 μm to about 1 mm, In other embodiments, the spheres may have a size of from about 2 μm to about 0.5 mm or about 5 μm to about 50 μm. The expanded spheres may increase about 1.5 to about 50 times from their original size after heat is applied. In other embodiments, expanded spheres may increase about 2 to about 25 or about 2 to about 10 times their original size after heat is applied.

In other embodiments, the sphere comprises a vinylidene chloride/acrylonitrile copolymer and isobutane.

In some embodiments, the foam may include a binder which can reinforce some properties of the foam. The binder may be a resinous material and may become plastified at a temperature below the thermoplastic temperature of the spheres. The binder may also surround some portion or all of the outer surface of the spheres to hold some or all of the particles together. In some embodiments, the binder may also bind to the coupling agent. The binder may be selected from, but not limited to, a solvent based adhesive containing methylene chloride, dimethyl glutarate, methyl methacrylate monomer, methyl acetate, methyl ethyl ketone, dichloromethane or a combination thereof.

Without being bound by theory, the coupling agent may react with free protons at the inorganic interface to form organic monomolecular layers on the thermoplastic material with a binder, the reinforcing material or a combination thereof.

The foam may include a reinforcing material. The reinforcing material can be dispersed with the thermoplastic material and may be, but not limited to, a carbon, thermoplastic or thermoset material. In some embodiments, the reinforcing agent is a rubber, a polybutadiene elastomer, a cross-linked acrylonitrile butadiene elastomer, a polybutadiene elastomer, a saturated acryl elastomer, a polyolefin elastomer, an ethylene-vinyl acetate elastomer or a combination thereof. In other embodiments, the reinforcing agent is an elastomer.

In some embodiments, the reinforcing agent is from about 0.1% to about 95% w/w of the composition. In other embodiments, the reinforcing agent is about 1% to about 90% or about 5% to about 75% w/w of the composition. The coupling agent may be mixed with the binder, the reinforcing materials or both, prior to mixing with the thermoplastic material. The coupling agents may bond the spheres, binder and reinforcing agent before the expansion process, during the expansion process or after the expansion process.

A stabilizer may also be used in the expandable or expanded compositions as disclosed herein. The stabilizer may be a hydroxide salt or a metal thereof.

For the foam to expand, heat may be applied. In some embodiments the heat may range from about 100° F. to about 750° F. In other embodiments, the heat may range from about 100° F. to about 450° F. or from about 100° F. to about 500° F.

One of the possible applications for the foam is as a sheet, open mold or injection-molded process. The foam mixture may be placed in, dispensed or injected into a heated chamber. Examples of a chamber the foam may utilize may include, but is not limited to, molds or enclosures made from epoxy, thermoplastics, aluminum, steel and stainless steel.

The molded products that may utilize the foam may include, without limitation, an exterior part for a vehicle, an interior part for a vehicle, a bicycle part, an audio-visual equipment part, an electrical appliance part, a computer part or a telephone part. Other possible applications may be as a furniture part, building material or fire retardant material. Another possible application is for a sporting good part.

In some embodiments, the foam may be used to make a safety helmet with an outer shell forming a cavity and an internal lining. This safety helmet may be adapted for football, lacrosse, hockey, baseball, driving, motor-cross, bicycling, riot control, construction or firefighting.

The foam may have an impact resistance of at least about 25 G/inch, at least about 50 G/inch, at least about 75 G/inch, at least about 100 G/inch, at least about 125 G/inch, at least about 150 G/inch, at least about 175 G/inch, at least about 200 G/inch, at least about 225 G/inch, at least about 250 G/inch, at least about 275 G/inch, at least about 300 G/inch or at least about 500 G/inch. In some embodiments, the foam may have an impact resistance from about 50 G/inch to about 450 G/inch, from about 100 G/inch to about 400 G/inch, from about 150 G/inch to about 350 G/inch or from about 200 G/inch to about 300 G/inch.

The expandable foam may also have a ratio of spheres to reinforcing agent of from about 1:1 to about 1:99. In other embodiments, the ratio may be from about 1:2 to about 1:9, from about 1:3 to about 1:8, from about 1:4 to about 1:7 or from about 1:6 to about 1:99.

The invention also discloses a method of preparing an expandable foam. The method includes preparing an expanded foam by combining spheres made form thermoplastic material, with the spheres containing a propellant material. The propellant material should become gaseous at a temperature below the thermoplastic temperature of the thermoplastic material. The method also includes a coupling agent which interacts or forms a bond between some or all of the adjacent spheres. The mixture may be heated to a temperature sufficient to cause plasticization of the material to form expanded spheres having a gaseous center. These spheres should then be cooled to a temperature below the thermoplastic temperature.

The method may also include preparing an expandable foam by mixing spheres made from a thermoplastic material, with the spheres having a propellant material contained therein, and a coupling agent which forms a bond between some of the adjacent spheres.

The method may be facilitated by mixing of the thermoplastic spheres with a coupling agent through, e.g., high sheer or ultra-high sheer mixing. The method may also include a binder and/or reinforcing agent being mixed with the thermoplastic spheres and coupling agent.

In some embodiments of the method, the spheres may be prepared in a reaction vessel with the polymerization of an unsaturated monomer material, or a mixture of monomer materials in an aqueous suspension in the presence of the propellant. In other embodiments, the method may include the monomer or monomer mixture suspended in the aqueous medium in the presence of a powder stabilizer.

The method may also use a coupling agent to form bonds between some of the spheres. The coupling aging may include, but is not limited to, transition metal atoms selected from the group consisting of Group IVB, Group VB and Group VIB of the Periodic Chart, transition metal alkoxide or maleic anhydride copolymer. In other embodiments, the coupling agent may be titanium or zirconium.

In certain embodiments of the method, the spheres may be microspheres. The spheres may have a shell that may be made from a thermoplastic material, such as a polymer or copolymer. The polymer or copolymer may be selected from, but is not limited to, vinyl chloride, vinylidene chloride, acrylonitrile with vinyl chloride, vinyl bromide, a halogenated vinyl compound or a combination thereof. The polymer or copolymer may also be selected from, but not limited to, styrene, o-methylstyrene, m-methylstyrene, p-methylstyrene, ethylstyrene, ar-vinyl-xylene, ar-chlorostyrene, ar-bromostyrene, vinylbenzylchloride, p-tert.-butylstyrene or a combination thereof.

In the methods of the invention, one of the possible materials that may comprise the thermoplastic shell of a sphere may be an acrylate material. The acrylate material may include, but is not limited to, methyl methacrylate, ethyl acrylate, propyl acrylate, butyl acrylate, butyl methacrylate, propyl methacrylate, butyl methacrylate, lauryl acrylate, 2-ethylhexylacrylate, ethyl methacrylate or a combination thereof.

In embodiments of the method, the coupling agent and the thermoplastic material may be mixed by ultrasonic waves, high sheer, ultra high sheer or a mixture thereof. The coupling agent may also be broken down into monomers and dispersed across the spheres prior to expansion.

In some of the method embodiments, the sphere can contain a liquid, such as a propellant. The propellant may be a volatile fluid-forming agent, such as an aliphatic hydrocarbon. The aliphatic hydrocarbon may be selected from, but is not limited to, ethane, ethylene, propane, propene, butene, isobutene, neopentane, acetylene, hexane, heptane, halogenated derivatives thereof and mixtures thereof. The propellant may also be selected from trichlorofluoromethane, n-pentane, iso-pentane, neopentane, butane, isobutane or a mixture thereof. The propellant may have a boiling point below the softening point of the thermoplastic material when saturated with the propellant.

In certain embodiments of the method, the propellant may be from about 1% to about 70% w/w of the sphere. In other embodiments, the propellant may be from about 2% to about 50% or from about 5% to about 30% w/w of the sphere.

Utilizing the methods of the invention, the unexpanded spheres may have a size from about 1 μm to about 1 mm. In other embodiments, the spheres may have a size of from about 2 μm to about 0.5 mm or from about 5 μm to about 50 μm. The expanded spheres may increase about 1.5 to about 50 times from their original size after heat is applied. In other embodiments, expanded spheres may increase about 2 to about 25 or about 2 to about 10 times their original size after heat is applied.

In other embodiments of the method, the sphere comprises a vinylidene chloride/acrylonitrile copolymer and isobutane.

In some method embodiments, the foam may include a binder which can reinforce some properties of the foam. The binder may be a resinous material and may become plastified at a temperature below the thermoplastic temperature of the spheres. The binder may also surround some portion of the outer surface of the spheres to hold some of the particles together. in some embodiments, the binder may also bind to the coupling agent. The binder may be selected from, but not limited to, a solvent based adhesive containing methylene chloride, dimethyl glutarate, methyl methacrylate monomer, methyl acetate, methyl ethyl ketone, dichloromethane or a combination thereof.

In the methods of the invention, the coupling agent may react with free protons at the inorganic interface to form organic monomolecular layers on the thermoplastic material with a binder, the reinforcing material or a combination thereof.

The method may include a reinforcing material in the foam. The reinforcing material can be dispersed with the thermoplastic material and may be, but not limited to, a carbon, thermoplastic or thermoset material. In some embodiments, the reinforcing agent is a rubber, a polybutadiene elastomer, a cross-linked acrylonitrile butadiene elastomer a polybutadiene elastomer, a saturated acryl elastomer, a polyolefin elastomer or an ethylene-vinyl acetate elastomer. In other embodiments, the reinforcing agent is an elastomer.

In some embodiments of the method, the reinforcing agent is from about 0.1% to about 95% w/w of the composition. In other embodiments, the reinforcing agent is about 1% to about 90% or about 5% to about 75% w/w of the composition. The coupling agent may be mixed with the binder, the reinforcing materials or both, prior to mixing with the thermoplastic material. The coupling agents may act by bonding the microspheres, binder and reinforcing agent before the expansion process, during the expansion process or after the expansion process.

A stabilizer may also be used in the method. The stabilizer may be a hydroxide salt or a metal thereof.

In certain methods of the invention, heat may be applied to expand the compositions. In some embodiments the heat may range from about 100° F. to about 750° F. In other embodiments, the heat may range from about 100° F. to about 450° F. or from about 100° F. to about 500° F.

The method may also have a ratio of spheres to reinforcing agent of from about 1:1 to about 1:99. In other embodiments, the ratio may be from about 1:2 to about 1:9, from about 1:3 to about 1:8, from about 1:4 to about 1:7 or from about 1:6 to about 1:99.

### EXAMPLES

### Example 1

In this example, the thermoplastic expandable microspheres in an unexpanded form are dispensed into a mixing chamber of a Henschel mixer to 96.5% of the total combined weight of the thermoplastic expandable microspheres and the coupling agent. The coupling agent in this example is made from zirconium and makes up 3.5% of the total weight of the thermoplastic expandable microspheres.

Prior to being placed in the Henschel mixer, the coupling agent is placed into an ultrasonic tube with a resonance above 50,000 hertz for 10 minutes. The coupling agent is then unloaded from the tube and dispensed at 3.5% of the total weight into the mixer. The mixer is sealed and turned on at a minimum of 5000 RPM for 10 minutes at room temperature. At all times the mixture temperature is kept below 180° F.

In alternative examples, a binder and/or a reinforcing material is used to make the foam to the desired qualities and specifications. In another alternative example, polycarbonate is used in a powder form and is dispensed into the mixture at 10% of the total weight. The mixer is sealed and turned on at a minimum of 5000 RPM for 10 minutes at room temperature. Again at all times the mixture temperature is kept below 180° F.

Once finished, the resultant mixture is dispensed into a hopper where it is dispensed into prepared molds. The molds are sealed and put through a conveyor oven at a temperature of 400° F. for between about 25-30 minutes. The materials expand in the mold and take the shape of the finished product.

The molds when finished cooking are removed from the conveyor and placed on a cooling rack until the mold temperature is below 100° F. The molds are then opened and the finished parts are removed. The materials can be painted, covered with a protective coating, and/or combined with other parts for a wide array of finished goods.

1. An expandable foam comprising (i) a plurality of spheres comprising a thermoplastic material, the spheres encapsulating a propellant material and (ii) a coupling agent forming a bond between at least a portion of adjacent spheres.

2. The expandable foam of claim 1, wherein the coupling agent forms a covalent bond between at least a portion of adjacent spheres.

3. The expandable foam of claim 1, wherein the coupling agent comprises transition metal atoms selected from the group consisting of Group IVB, Group VB and Group VIB of the Periodic Chart.

4. The expandable foam of claim 1, wherein the coupling agent comprises titanium or zirconium.

5. The expandable foam of claim 1, wherein the coupling agent is a transition metal alkoxide.

6. The expandable foam of claim 1, wherein the coupling agent is a maleic anhydride copolymer.

7. The expandable foam of claim 1, wherein the spheres are microspheres.

8. The expandable foam of claim 1, wherein the thermoplastic material is a polymer.

9. The expandable foam of claim 8, wherein the polymer is an acrylate material.

10. The expandable foam of claim 9, wherein the acrylate material is selected from the group consisting of methyl methacrylate, ethyl acrylate, propyl acrylate, butyl acrylate, butyl methacrylate, propyl methacrylate, butyl methacrylate, lauryl acrylate, 2-ethylhexylacrylate, ethyl methacrylate, and a combination thereof.

11. The expandable foam of claim 8, wherein the polymer is a polymer or copolymer of vinyl chloride, vinylidene chloride, acrylonitrile with vinyl chloride, vinyl bromide or a halogenated vinyl compound.

12. The expandable foam of claim 8, wherein the polymer is a polymer or copolymer of styrene, o-methylstyrene, m-methylstyrene, p-methylstyrene, ethylstyrene, ar-vinyl-xylene, ar-chlorostyrene, or ar-bromostyrene.

13. The expandable foam of claim 8, wherein the polymer is a polymer or copolymer of vinylbenzylchloride or p-tert.-butylstyrene.

14. The expandable foam of claim 1, wherein the propellant is a volatile fluid-forming agent.

15. The expandable foam of claim 14, wherein the fluid forming agent is an aliphatic hydrocarbon.

16. The expandable foam of claim 15, wherein the aliphatic hydrocarbon is selected from the group consisting of ethane, ethylene, propane, propene, butene, isobutene, neopentane, acetylene, hexane, heptane, halogenated derivatives thereof and mixtures thereof.

17. The expandable foam of claim 1, wherein the propellant has a boiling point below the softening point of the thermoplastic material when saturated with the propellant.

18. The expandable foam of claim 1, wherein the propellant is trichlorofluoromethane, n-pentane, isopentane, neopentane, butane, isobutane or a mixture thereof.

19. The expandable foam of claim 1, wherein the propellant is from about 1% to about 70% w/w of the sphere.

20. The expandable foam of claim 1, wherein the propellant is from about 2% to about 50% w/w of the sphere.

21-150. (canceled)
